(19) United States
(12) Patent Application Publication
(10) Pub. No.: US 2025/0097133 A1
(43) Pub. Date: Mar. 20, 2025

(54) SYSTEM AND METHOD FOR DETERMINING HEALTH STATUS OF NODES

(71) Applicant: Alkira, Inc., San Jose, CA (US)

(72) Inventors: Teja Kiran Chunduri, Milpitas, CA (US); Ashish Shendure, Bear, DE (US); Kwang II Kim, San Jose, CA (US); Ameena Golding, Oakland, CA (US)

(21) Appl. No.: 18/892,123

(22) Filed: Sep. 20, 2024

Related U.S. Application Data
(60) Provisional application No. 63/584,138, filed on Sep. 20, 2023.

(51) Int. Cl. H04L 43/0817

(52) U.S. Cl. CPC H04L 43/0817

(57) ABSTRACT

A system and a method are provided for determining a health status of a plurality of nodes of a network. The system obtains a set of operational characteristics associated with each of the plurality of nodes of the network, determines a health status of each of the plurality of nodes based on the corresponding set of operational characteristics, and outputs a network architecture of the network to display based on the determined health status. The set of operational characteristics indicate at least traffic data associated with a corresponding node from the plurality of nodes. The health status indicates a current working condition of each of the plurality of nodes. The network architecture indicates a hierarchical node-level view of the plurality of nodes, wherein the network architecture indicates health status of each of the plurality of nodes.

### TECHNOLOGICAL FIELD

The present disclosure generally relates to managing network nodes within a network, and more particularly relates to determining health status of network nodes within the network.

### BACKGROUND

As network architecture continue to grow in size and complexity, a number of nodes or devices deployed and running within a network becomes difficult to manage. Further, in a network environment, it may be crucial to ensure reliable operation of the nodes or devices so that the network environment is accessible and transmitting and/or receiving of data over the network environment is quick and secure.

### BRIEF SUMMARY

The present disclosure may provide a system and a method that enables determination of health status of plurality of nodes of a network.

In one aspect, a system for determining a health status of a plurality of nodes of a network is provided. The system comprises a memory configured to store computer executable instructions, and one or more processors that are configured to execute the instructions. The processors are configured to obtain a set of operational characteristics associated with each of the plurality of nodes of the network. The set of operational characteristics indicate at least traffic data associated with a corresponding node from the plurality of nodes. The processors are configured to determine a health status of each of the plurality of nodes based on the corresponding set of operational characteristics. The health status indicates a current working condition of each of the plurality of nodes. The processors are configured to output a network architecture of the network to display based on the determined health status. The network architecture indicates a hierarchical node-level view of the plurality of nodes, wherein the network architecture indicates health status of each of the plurality of nodes.

In additional system embodiments, the set of operational characteristics of a node further comprises at least one of: test data, network data, historical network data, performance data, or the traffic data.

In additional system embodiments, the processors are configured to receive a request relating to at least one of: transmitting, or receiving of data, identify at least one available node from the plurality of nodes based on the request and the determined health status of each of the plurality of the nodes, and cause to use the identified available node for completing the request.

In additional system embodiments, the plurality of nodes relate to network resources of the network.

In another aspect, a method for determining a health status of a plurality of nodes of a network is provided. The method comprises obtaining a set of operational characteristics associated with each of the plurality of nodes of the network. The set of operational characteristics indicates at least traffic data associated with a corresponding node from the plurality of nodes. The method comprises determining a health status of each of the plurality of nodes based on the corresponding set of operational characteristics. The health status indicates a current working condition of each of the plurality of nodes. The method comprises outputting a network architecture of the network to display based on the determined health status. The network architecture indicates a hierarchical node-level view of the plurality of nodes, wherein the network architecture indicates health status of each of the plurality of nodes.

### BRIEF DESCRIPTION OF THE DRAWINGS

Having thus described example embodiments of the disclosure in general terms, reference will now be made to the accompanying drawings, which are not necessarily drawn to scale, and wherein:

FIG. 1 depicts a schematic diagram of a network to be managed, in accordance with an example embodiment of the present disclosure;

FIG. 2 illustrates a block diagram of a network node, in accordance with an example embodiment of the present disclosure;

FIG. 3 illustrates a block diagram of a computing node, in accordance with an example embodiment of the present disclosure;

FIG. 4 illustrates a block diagram of a system for determining health status of a plurality of nodes, in accordance with an example embodiment of the present disclosure;

FIG. 5 illustrates a schematic diagram of a network architecture, in accordance with an example embodiment of the present disclosure; and

FIG. 6 illustrates a flowchart of a method for determining a health status of the plurality of nodes, in accordance with an example embodiment of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced item. Moreover, various features are described which may be exhibited by some embodiments and not by others. Similarly, various requirements are described which may be requirements for some embodiments but not for other embodiments.

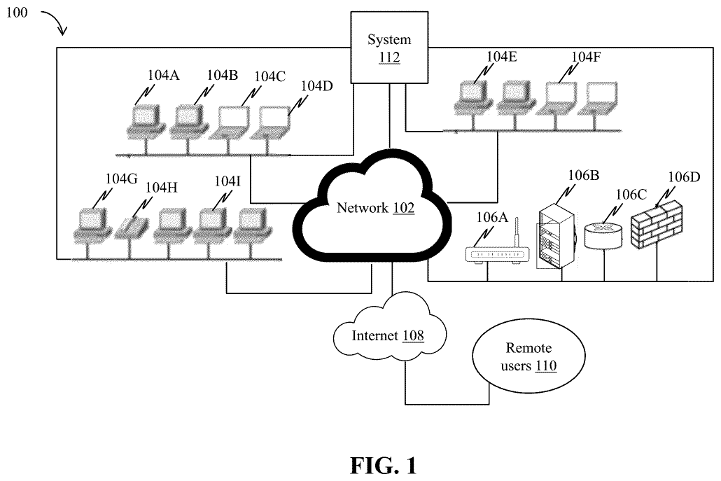

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect. Turning now to FIG. 1-FIG. 6, a brief description concerning the various components of the present disclosure will now be briefly discussed. Reference will be made to the figures, showing various embodiments of a system for providing a user with an interactive map.

Embodiments of the present disclosure aim to overcome problems relating to conventional method for managing nodes or devices within a network. For example, a number of network nodes and/or other computing nodes within a network architecture may be large. Moreover, monitoring health of the network nodes and/or the other computing nodes in the network architecture may be challenging, especially, if the network architecture belongs to a large enterprise having multitude of nodes.

Conventionally, users or network administrators may have to create tabular sheets for monitoring usage, health, performance, etc. of each of a plurality of nodes within a network. For example, the users or the network administrators may have to manually inspect operation of a node and further manually update information regarding usage, health, performance, etc. of each of the plurality of nodes, for example, in a software. Such monitoring and management of nodes of the network may be challenging and laborious. Moreover, in cases of sudden failure or crash of a node, its corresponding information may not be updated in real-time. This may hamper user experience and potentially lead to user frustration.

In certain cases, in order to identify a faulty node, the users or the network administrators may have to go through the entire tabular sheet, which is time consuming and may delay a repair and/or a recovery process.

Embodiments of the present disclosure provide system and method for optimizing monitoring and management of nodes or devices within a network in more user-friendly manner.

FIG. 1 depicts a schematic diagram 100 of a network 102 to be managed, in accordance with an example embodiment. The diagram 100 may include the network 102. The network 102 may provide connectivity among users, devices, and applications. The network 102 may be utilized by a collection of devices or nodes to be connected to each other. The connection formed by the network 102 may facilitate different components connected to the network 102 (e.g., nodes) to communicate and share resources. In an example, the network 102 relates to an enterprise network.

In this regard, a plurality of computing nodes (depicted as computing nodes 104A, 104B, 104C, 104D, 104E, 104F, 104G, 104H and 104I, collectively referred to as computing nodes 104) may be connected to the network 102. The computing nodes 104 may be associated with corresponding users to enable the users to access resources, software, applications, etc. Examples of the computing nodes 104 may include, but is not limited to, smartphones, laptops, desktops, servers, file servers, databases, and personal digital assistants. Further, a plurality of network nodes (depicted as network nodes 106A, 106B, 106C and 106D, collectively referred to as network nodes 106 may be used to establish the network 102. The network nodes 106 may enable the computing nodes 104 to access the resources, software, applications, etc. Examples of the network nodes 106 may include, but is not limited to, routers, firewalls, Wi-Fi routers, web servers, repeaters and switches.

The nodes connected to the network 102 may include the computing nodes 104 and the network nodes 106. In an example, certain remote users 108 may also access resources by connecting to the network 102 over the Internet 110. In an example, the network 102 is configured to enable exchange of electronic communications between nodes 106 connected to the network 102.

It may be noted that examples of the computing nodes 104, network nodes 106 and the remote users 108 is only exemplary. In other embodiments, more or lesser components may be connected in other configurations with the network 102.

The network 102 may include, for example, one or more of the Internet, Wide Area Networks (WANs), Local Area Networks (LANs), analog or digital wired and wireless telephone networks (e.g., a public switched telephone network (PSTN), Integrated Services Digital Network (ISDN), a cellular network, and Digital Subscriber Line (DSL)), radio, television, cable, satellite, or any other delivery or tunneling mechanism for carrying data. The network 102 may include multiple networks or sub-networks, each of which may include, for example, a wired or wireless data pathway. The network 102 may include a circuit-switched network, a packet-switched data network, or any other network able to carry electronic communications (e.g., data or voice communications). For example, the network 102 may include networks based on the Internet protocol (IP), asynchronous transfer mode (ATM), the PSTN, packet-switched networks based on IP, X.25, or Frame Relay, or other comparable technologies and may support voice using, for example, VoIP, or other comparable protocols used for voice communications. The network 102 may include one or more networks that include wireless data channels and wireless voice channels. The network 102 may be a wireless network, a broadband network, or a combination of networks including a wireless network and a broadband network.

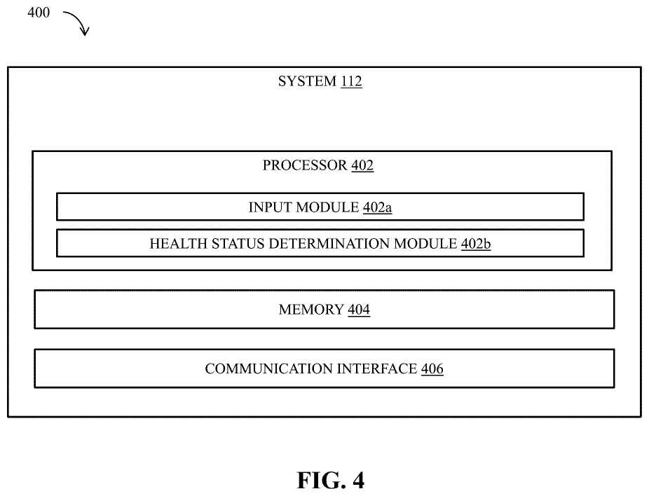

Further, the diagram 102 may also include a system 112 for determining a health status of the plurality of nodes (such as, the computing nodes 104 and the network nodes 106) of the network 102. A manner in which the system 112 may be configured to monitor the health status of the nodes 104 and 106 is described, for example, in conjunction with FIG. 4-FIG. 6.

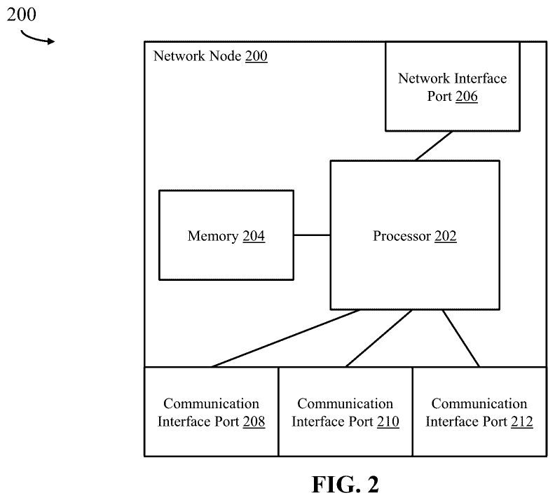

FIG. 2 illustrates a block diagram of a network node 200, in accordance with an example embodiment. The network node 200 may be a network resource provided by a service provider for providing a service to a user. In an example, the network node 200 may correspond to the network nodes 106, or any other network node connected to the network 102. In an example, the network node 200 may be coupled to the system 112, in certain cases, to enable management and monitoring of the network node 200.

The Network node 200 includes a processor 202 operatively coupled to a memory 204, a network interface port 206, a communication interface port 208, a communication port 210, and a communication port 212. The processor 202 is configured to communicate with computing devices such as the computing nodes 104, host devices (e.g., servers in a network of the service provider) and virtual resources hosted by host devices via the communication interface port 208, the communication interface port 210, and the communication interface port 212. In some embodiments, the network node 200 may include more or fewer communication interface ports than are illustrated in FIG. 2. The network node 200 may include, for example, 64, 128, 256, or more communication interface ports.

In an example, the network node 200 is configured to receive data packets and forward the data packets to one or more of the network interface port 206 and/or the communication interface ports 208, 210 and 212, based on parameters of the data packets. For example, a data packet received via the network interface port 206 may include a destination parameter having a value associated with an identifier of a computing device connected to any one of the communication interface ports 208, 210 and 212, say port 208. The processor 202 may determine to which communication interface port, if any, the packet should be forwarded based on, for example, data stored in memory 204. Because the data packet includes a destination parameter having a value associated with an identifier of a computing device connected to the communication interface port 208, the processor 202 may determine that the data packet should be forwarded to the communication interface port 208. In an example, the memory 204 may include rules and/or ACLs (provided as provisioning instructions from a management entity via a network management module that are satisfied by parameters of the data packet before the processor 202 forwards the data packet. For example, a rule can specify that a source address parameter of the data packet include a value in a range of values specified in the rule. If the value is outside of the specified range of values, the data packet will not be forwarded to the communication interface 208.

In another example, the network node 200 may be configured as a network switch such as an access switch coupled to a switch fabric. For example, the network node 200 may be an access switch configured to communicate with host devices and/or other devices (e.g., storage servers, database servers, and/or other computer servers) of service provider via a protocol, such as Ethernet through the communication ports 208, 210 and 212, and communicate with a core of a switch fabric via another protocol (for example, a cell-based protocol or other protocol other than Ethernet) through the network interface port 206. In other words, the network node 200 may provide host devices and/or other devices configured to communicate via one protocol with access to a switch fabric configured to communication via another protocol.

More specifically, for example, the core of a switch fabric may be configured as a strictly non-blocking network or re-arrangeable non-blocking network such as a Clos network, and may include a data plane and a control plane. Thus, two host devices can be operatively coupled one to another via two network resources, such as network nodes (each similar to the network node 200) operatively coupled to a switch fabric. For example, a first host device can send a data packet addressed to a second host device via an Ethernet protocol to a first network node operatively coupled to a switch fabric. The first network node can receive the data packet and send the data packet via the switch fabric using a proprietary protocol to a second network node operatively coupled to the second network node. For example, first network node can send the data packet to the second network node by separating or segmenting the data packet into cells that are transported via a cell-based switch fabric based on data signals in a data plane and a control plane of the switch fabric. Alternatively, in some embodiments the switch fabric can segment the data packet prior to transporting it to the second network node. The second network node can then receives the cells representing the segmented data packet, reassemble the data packet, and send the data packet to the second host device via an Ethernet protocol. Alternatively, the switch fabric can reassemble the data packet based on the cells representing the data packet prior to providing the data packet to the second network node.

In yet another example, the network node 200 may be configured to function as a gateway device between a switch fabric and a host device, virtual resources hosted by the host device, and/or other devices, which can be configured to transfer data based on different protocols. For example, the host device and the virtual resources hosted by the host device may be configured to communicate based on an Ethernet protocol and the switch fabric may be a cell-based fabric where one or more portions of data (e.g., data packets) are transmitted via the switch fabric in one or more cells (e.g., variable size cells, fixed size cells). In other words, the network node 200 may provide the host device and/or other devices configured to communicate via one protocol with access to the switch fabric, which can be configured to communicate via another protocol. In some embodiments, the network node 200 may be configured to function as a router, a network hub device, and/or a network bridge device. In some embodiments, a routing can be layer-2 switching and/or layer-3 routing. In other words, a router may be a device configured to classify and/or operate on packets at layer-2 or layer-3.

Additionally, in another example, the network node 200 may be configured to function as a gateway device for multiple host devices. In some embodiments, network node 200 may include a control interface port (not shown). The control interface port may be used for communicating with, for example, the system 112 or a network management module associate with a service provider of the network node 200. For example, the network management module may be incorporated into a control plane of the network 102 of a user or an enterprise and the network node 200 may be operatively coupled to the control plane of the network 102 via the control interface. For example, the network node 200 may communicate with the system 112 via the network interface port 206 and/or the communication interface ports 208, 210 and 212 to enable monitoring of the network node 200.

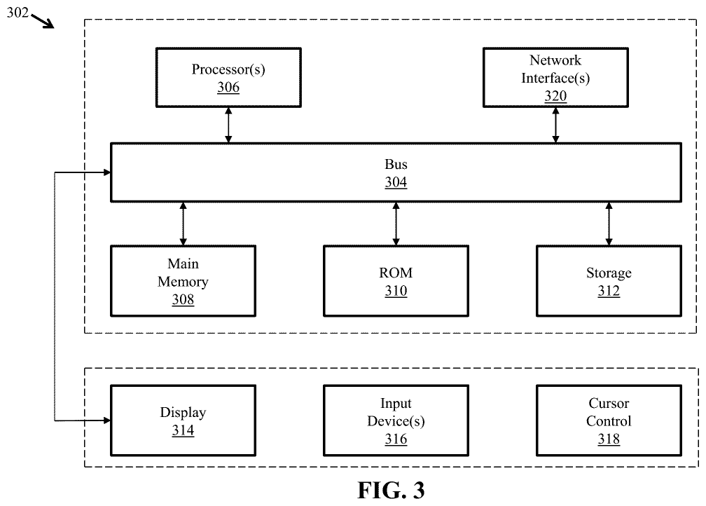

FIG. 3 shows a diagram of an example computing node 302, in accordance with an example embodiment. In an example, the computing node 302 may correspond to the computing nodes 104, or any other computing device connected to the network 102. In an example, the computing node 302 may be coupled to the system 112, in certain cases, to enable management and monitoring of the computing node 302.

The computing node 302 includes a bus 304 or other communication mechanism for communicating information, one or more hardware processors (referred to as the processor) 306 coupled with the bus 304 for processing information, and a main memory (referred to as the memory) 308 coupled to the bus 304 for storing information and instructions to be executed by the processor 306. The memory 308 may also be used for storing temporary variables or other intermediate information during execution of instructions to be executed by the processor 306. Such instructions, when stored in storage media accessible to the processor 306, render the computer system into a special-purpose machine configured to perform the operations specified in the instructions. Such instructions may be read into the memory 308 from another storage medium, such as the storage device 312. Execution of the sequences of instructions contained in the memory 308 causes the processor 306 to perform process steps, such as those described in this paper, to act as a specially purposed machine.

The computing node 302 further includes, coupled to the bus 304, a read only memory (ROM) 310 or other static storage device, such as a magnetic disk, optical disk, or USB thumb drive (Flash drive), for storing static information and instructions for the processor 306, a display 314, such as a liquid crystal display (LCD) (or touch screen) for displaying information to a computer user, an input device 316, such as a keyboard including alphanumeric and other keys for communicating information and command selections to the processor 306, and a cursor control device 318, such as a mouse, a trackball, cursor direction keys, or other type of input device for communicating information and/or command selections to the processor 306 and for controlling cursor movement on the display 314. Instead or in addition, the same information and command selections as cursor control may be implemented via receiving touches on a touch screen (e.g., of the display 314 or some other device with a screen).

The computing node 302 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component” may refer to logic embodied in hardware or firmware, or to a collection of software instructions, possibly having entry and exit points, written in a programming language, such as, for example, Java, C or C++. An engine may include hardware or firmware. The term “engine,” is not intended to represent a “software engine.” A software component may be compiled and linked into an executable program, installed in a dynamic link library, or may be written in an interpreted programming language such as, for example, BASIC, Perl, or Python. It may be noted that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as the storage device 312. Volatile media includes dynamic memory, such as the memory 308. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise the bus 304. Transmission media can also take the form of acoustic or light waves, such as those generated during radio-wave and infra-red data communications.

The computing node 302 may also include one or more network interfaces (referred to as the communication interface) 320 coupled to the bus 304. The communication interface 320 provides a two-way data communication coupling to one or more network links that are connected to one or more local networks. For example, the communication interface 320 may be an integrated services digital network (ISDN) card, cable modem, satellite modem, or a modem to provide a data communication connection to a corresponding type of telephone line. In another example, the communication interface 320 may be a local area network (LAN) card to provide a data communication connection to a compatible LAN (or WAN component to communicate with a WAN). Wireless links may also be implemented. In such an implementation, the communication interface 320 sends and receives electrical, electromagnetic or optical signals that carry data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the worldwide packet data communication network now commonly referred to as the “Internet.” Local network and Internet both use electrical, electromagnetic or optical signals that carry digital data streams. The signals through the various networks and the signals on network link and through the communication interface 320, which carry the digital data to and from the computer system, are example forms of transmission media.

In operation, the computing node 302 may send messages and receive data, including program code, through the network(s), network link, and the communication interface 320. In an example, a server might transmit a requested code for an application program through the Internet, the ISP, the local network and the communication interface 320. The received code may be executed by the processor 306 as it is received, and/or stored in the storage device 312, or other non-volatile storage for later execution or playback.

Each of the processes, methods, and algorithms described in the present disclosure may be embodied in, and fully or partially automated by, code components executed by the computing node 302 or computer processors comprising computer hardware. The computing node 302 or computer processors may also operate to support performance of the relevant operations in a “cloud computing” environment or as a SaaS. The processes and algorithms may be implemented partially or wholly in application-specific circuitry. The various features and processes described above may be used independently of one another or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto.

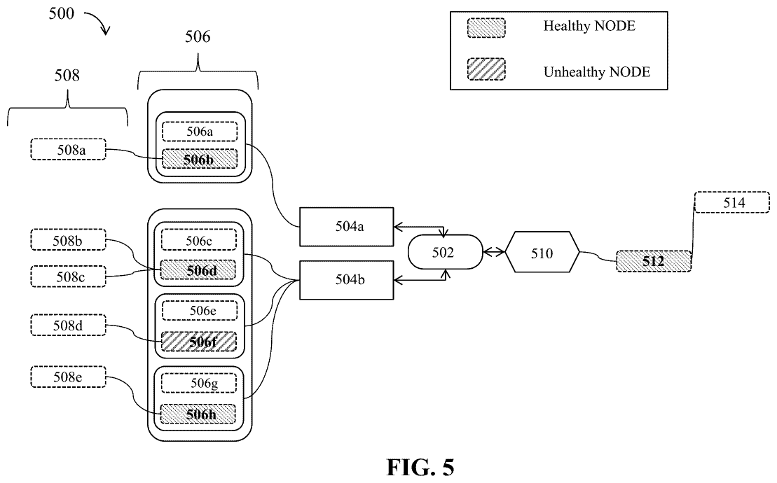

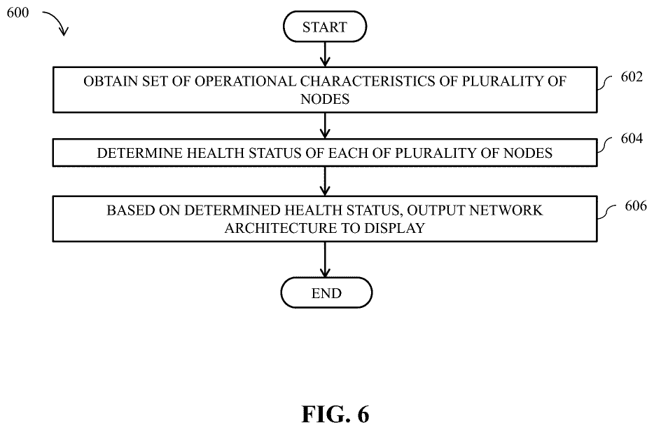

A manner in which the system 112 operates to perform processes for management of the nodes 104 and 106 is described in detail in conjunction with FIG. 4, FIG. 5 and FIG. 6.

FIG. 4 illustrates a block diagram 400 of the system 112 implemented for determining health status of a plurality of nodes associated with the network 102, in accordance with an example embodiment. The system 112 may include a processor 402, a memory 404 and a communication interface 406. Further, the processor 402 may include an input module 402a and a health status determination module 402b.

The processor 402 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 402 may include one or more processing cores configured to perform independently. A multi-core processor may enable multiprocessing within a single physical package. Additionally, or alternatively, the processor 402 may include one or more processors configured in tandem via the bus to enable independent execution of instructions, pipelining and/or multithreading. Additionally, or alternatively, the processor 402 may include one or more processors capable of processing large volumes of workloads and operations to provide support for big data analysis. In an example embodiment, the processor 402 may be in communication with the memory 404 via a bus for passing information among components of the system 112.

In an example, when the processor 402 is embodied as an executor of software instructions, the instructions may specifically configure the processor 402 to perform the algorithms and/or operations described herein when the instructions are executed. However, in some cases, the processor 402 may be a processor specific device (for example, a mobile terminal or a fixed computing device) configured to employ an embodiment of the present disclosure by further configuration of the processor 402 by instructions for performing the algorithms and/or operations described herein. The processor 402 may include, among other things, a clock, an arithmetic logic unit (ALU) and logic gates configured to support operation of the processor 402. The network environment may be accessed using a communication interface 406 of the system 112. The communication interface 406 may provide an interface for accessing various features and data stored in the system 112.

The memory 404 may be non-transitory and may include, for example, one or more volatile and/or non-volatile memories. In other words, for example, the memory 404 may be an electronic storage device (for example, a computer readable storage medium) comprising gates configured to store data (for example, bits) that may be retrievable by a machine (for example, a computing device like the processor 402). The memory 404 may be configured to store information, data, content, applications, instructions, or the like, for enabling the system 112 to carry out various functions in accordance with an example embodiment of the present disclosure. For example, the memory 404 may be configured to buffer input data for processing by the processor 402. The memory 404 may be configured to store instructions for execution by the processor 402. As such, whether configured by hardware or software methods, or by a combination thereof, the processor 402 may represent an entity (for example, physically embodied in circuitry) capable of performing operations according to an embodiment of the present disclosure while configured accordingly. Thus, for example, when the processor 402 is embodied as an ASIC, FPGA or the like, the processor 402 may be specifically configured hardware for conducting the operations described herein.

In some example embodiments, the communication interface 406 may be wired, wireless, or any combination of wired and wireless communication networks, such as cellular, Wi-Fi, internet, local area networks, or the like. In some embodiments, the communication interface 406 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

In one embodiment, the input module 402a of the processor 402 may be configured to obtain a set of operational characteristics of the plurality of nodes, such as the nodes 104 and 106 associated with the network 102. The set of operational characteristics for a node, say 104A may indicate at least traffic data associated with the node 104A. For example, based on the traffic data obtained by the input module 402a, information relating to activity, i.e., sending and/or receiving data, associated with the node 104A may be determined. Further, the traffic data may be utilized to determine health status of the node 104A associated with the network 102.

Further, the health status determination module 402b of the processor 402 may be configured to determine a health status of each of the plurality of nodes based on the corresponding set of operational characteristics. The health status of the node 104A indicates a present working condition of the node 104A. For example, the health status of the node 104A may indicate a state of use and a performance of the node 104A. The health status may also indicate if the node 104A is healthy or unhealthy, i.e., operating as expected or not. Furthermore, based on the determined health status each of the plurality of nodes 104 and 106, a network architecture may be displayed.

In an example, the processor 402 may be further configured to output the network architecture of the network 102 to display based on the determined health status of the each of the plurality of nodes 104 and 106. The network architecture may be displayed to indicate a link or connection between the plurality of the nodes 104 and 106 in a hierarchical manner. The network architecture may enable users or network administrators associated with the network 102 to view and/or analyze health condition of each of the plurality of nodes 104 and 106. The network architecture may also output a hidden node or a sub-node associated a node of plurality of nodes 104 and 106.

For example, a user may interact with the network architecture. In an example, the user may provide an input by clicking or touching a block of the network architecture that indicates a node, say the node 104A from the plurality of nodes 104 and 106. Based on the input, the block of the network architecture may expand to provide details associated with, for example, performance of the node 104A, the health status of the node 104A, the hidden and/or sub-nodes associated with the node 104A, and diagnosis for the node 104A in case the node 104A is experiencing a fault or is down. The network architecture may indicate a hierarchical node-level view of the plurality of nodes. Further, the network architecture may indicate health status of each of the plurality of nodes. Details of the network architecture are described in detail in, for example, FIG. 5.

In some embodiments, the processor 402 is further configured to execute the instructions to receive a request relating to transmitting and/or receiving of data, such as data packets. Further, the processor 402 may also be configured to identify at least one available node from the plurality of nodes for delivering the data, based on information within a header of the data packets and health status of the plurality of nodes 104 and 106. Furthermore, the processor 402 may also cause the system 112 to use the identified available node for completing the request. The system 112 may cause the available node to transfer the data packets to a corresponding destination. In this manner, transmitting of data packets may not be interrupted even if a node is down. For example, if the node is a computing node which is down, then the processor may identify other available node(s) associated with a user of the node that is down to provide the data.

Further, in some embodiments, the memory 404 may be read only memory (ROM) and random access memory (RAM). The memory 404 may be non-transitory and may include, for example, one or more volatile and/or non-volatile memories. The memory 404 of the system 112 may be configured to store a dataset (such as, but not limited to, the set of operation characteristics, the determined health status, the configuration of the nodes 104 and 106 within the network 102, and the network architecture) associated with the plurality of nodes 104 and 106. In accordance with an embodiment, the memory 404 may include processing instructions for determining health status and outputting the network architecture.

FIG. 5 illustrates a schematic diagram of a network architecture 500 depicting a topology of the plurality of nodes 104 and 106 connected to the network 102 in a horizontal layout, in accordance with an example embodiment. The network architecture 500 may be, for example, architecture of a local area network (LAN) and/or a wide area network (WAN) associated with a display (not show in the drawings). The network architecture 500 indicates a hierarchical node-level view of the nodes 104 and 106 of the network 102.

As shown, the network architecture 500 includes various nodes 502, 504, 506 and 508, indicating the plurality of nodes 104 and 106 of the network 102 connected or linked to each other. The network architecture 500 may include border node or end node 502, distribution nodes (504a and 504b), access layer nodes (depicted as 506a, 506b, 506c, 506d, 506e, 506f, 506g, and 506h and collectively referred to as access layer nodes 506), and low-level nodes (depicted as 508a, 508b, 508c, 508d and 508e, and collectively referred to as low-level nodes 508). Further, the network architecture 500 may also include a connector that is utilized to facilitate connection between a service provider 512 and the border node 502, for example, via resources 510. The service provider 512 may be connected to a service infrastructure node 514, such as service providers VPC, compute resource, etc.

In some embodiment, the processor 402 may be configured to output the network architecture 500 of the nodes 104 and 106 connected through the network 102 to display. The network designer or the network administrator may be able to access the network architecture 500 displayed on a display screen to modify, design and/or identify health status of the plurality of nodes 402, 404, 406, 408, 104 and 106 of the network 102.

In an example, the plurality of nodes 402, 404, 406 and 408 may correspond to network nodes 106 within the network 102. However, this should not be construed as a limitation and the network architecture 500 may also include the computing nodes 104. For example, the plurality of nodes 402, 404, 406 and 408 may represent network resources associated with the network 102, such as the plurality of nodes 402, 404, 406 and 408 may be one or more of: a router, servers, or hardware network devices that can be accessed through or utilized to set-up a local area network (LAN) or enterprise intranet. Further, the network architecture 500 indicates a node-level view that is periodically updated automatically. Subsequently, the network architecture 500 may indicate updated health status information associated with the plurality of the nodes 104 and 106 operating within the network 102.

FIG. 6 illustrates a method flowchart 600 for determining a health status of the plurality of nodes 104 and 106 associated with the network 102, in accordance with an example embodiment of the present disclosure. In an example the processor 402 may be configured to determine the health status of the plurality of nodes 104 and 106 associated with the network 102.

At 602, a set of operational characteristics of the plurality of the nodes 104 and 106 is obtained. The plurality of nodes 104 and 106 may be associated with the network 102. The set of operational characteristics may be obtained in order to determine the health status of the plurality of the node. For example, the set of operational characteristics may include, but is not limited to, test data, network data, historical network data, performance data, or traffic data.

At 604, the health status of each of the plurality of the nodes 104 and 106 is determined. The health status may be determined based on the corresponding set of operational characteristics. The health status may indicate a present working condition or performance of the plurality of nodes 104 and 106. For example, the health status may signify whether operation of the plurality of nodes 104 and 106 is suitable or fit for use by a user. on

At 606, the network architecture 500 of the plurality of nodes 104 and 106 associated with the network 102 is outputted to display based on the determined health status. The network architecture 500 indicates a hierarchical node-level view of the plurality of nodes 104 and 106. The network architecture 500 indicates detailed health report and health status of each of the plurality of nodes 104 and 106. For example, blocks of the network architecture 500 indicating the plurality of nodes 104 and 106 may be expanded or collapsed. In an example, an expanded view of a block may show detailed information relating to the health status of the corresponding node. Moreover, the network architecture 500 is displayed in a hierarchical manner. This may be advantageous in easily identifying nodes that are sub-nodes or child nodes from a same parent node. For example, due to a fault in operation of the parent node, operations of the corresponding child nodes may also be affected. Therefore, quick identification of affected nodes during downtime may enable quick restoration, prevent increased downtime and enhance user experience.

To this, instead of having to create laborious tabular sheets for managing plurality of nodes, the network architecture enables visual depiction of functioning information and health status of the plurality of nodes for ease of user access and management.

For example, the network architecture of the hierarchical node-level view of the plurality of nodes represent all the functional, performance and other health related data of the plurality of nodes in a succinct and easy to understand manner. Moreover, the health status of the plurality of nodes is determined automatically. Further, the use of the network architecture makes it possible for the users to easily identify a node that may not be operating properly, for example, a node having downtime or facing any other issue relating to sending and/or receiving traffic data. Further, the network architecture enables to ensure successful device service and maintenance of network nodes. The status overviews and real-time database information allow for maintenance to be planned from one central location, and device swaps to be prepared in advance.

Accordingly, blocks of the flowchart 600 support combinations of means for performing the specified functions and combinations of operations for performing the specified functions. It will also be understood that one or more blocks of the flowchart 500, and combinations of blocks in the flowchart 600, can be implemented by special purpose hardware-based computer systems which perform the specified functions, or combinations of special purpose hardware and computer instructions.

Alternatively, the system 112 may comprise means for performing each of the operations described above. In this regard, according to an example embodiment, examples of means for performing operations may comprise, for example, the processor 402 and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A system for determining a health status of a plurality of nodes of a network, comprising:
a memory configured to store computer executable instructions; and
one or more processors are configured to execute the instructions to:
obtain a set of operational characteristics associated with each of the plurality of nodes of the network, the set of operational characteristics indicating at least traffic data associated with a corresponding node from the plurality of nodes;
determine a health status of each of the plurality of nodes based on the corresponding set of operational characteristics, wherein the health status indicates a current working condition of each of the plurality of nodes; and
based on the determined health status, output a network architecture of the network to display, the network architecture indicating a hierarchical node-level view of the plurality of nodes, wherein the network architecture indicates health status of each of the plurality of nodes.

2. The system of claim 1, wherein the set of operational characteristics of a node further comprises at least one of: test data, network data, historical network data, performance data, or the traffic data.

3. The system of claim 1, wherein the one or more processors are configured to execute the instructions to:
receive a request relating to at least one of: transmitting, or receiving of data;
based on the request and the determined health status of each of the plurality of the nodes, identify at least one available node from the plurality of nodes; and
cause to use the identified available node for completing the request.

4. The system of claim 1, wherein the plurality of nodes relate to network resources of the network.

5. A method for determining a health status of a plurality of nodes of a network, comprising:
obtaining a set of operational characteristics associated with each of the plurality of nodes of the network, the set of operational characteristics indicating at least traffic data associated with a corresponding node from the plurality of nodes;
determining a health status of each of the plurality of nodes based on the corresponding set of operational characteristics, wherein the health status indicates a current working condition of each of the plurality of nodes; and
based on the determined health status, outputting a network architecture of the network to display, the network architecture indicating a hierarchical node-level view of the plurality of nodes, wherein the network architecture indicates health status of each of the plurality of nodes.

6. The method of claim 5, wherein the set of operational characteristics further comprises at least one of: test data, network data, historical network data, or performance data.

7. The method of claim 5, further comprising receiving a request relating to at least one of: transmitting or receiving of data.

8. The method of claim 7, further comprising, based on the request and the determined health status of each of the plurality of nodes, identifying at least one available node from the plurality of nodes.

9. The method of claim 8, further comprising causing the identified available node to be used for completing the request.

10. The method of claim 5, wherein the network architecture is displayed in a hierarchical manner.

11. The method of claim 5, further comprising updating the network architecture periodically to reflect the current health status of the plurality of nodes.

12. The method of claim 5, wherein the network architecture includes a visual indicator for each node to represent its health status.

13. The method of claim 5, further comprising generating alerts based on the determined health status of the plurality of nodes.

14. A non-transitory computer-readable medium storing instructions that, when executed by one or more processors, cause the one or more processors to perform a method for determining a health status of a plurality of nodes of a network, the method comprising:
obtaining a set of operational characteristics associated with each of the plurality of nodes of the network, the set of operational characteristics indicating at least traffic data associated with a corresponding node from the plurality of nodes;
determining a health status of each of the plurality of nodes based on the corresponding set of operational characteristics, wherein the health status indicates a current working condition of each of the plurality of nodes; and
based on the determined health status, outputting a network architecture of the network to display, the network architecture indicating a hierarchical node-level view of the plurality of nodes, wherein the network architecture indicates health status of each of the plurality of nodes.

15. The non-transitory computer-readable medium of claim 14, wherein the set of operational characteristics further comprises at least one of: test data, network data, historical network data, or performance data.

16. The non-transitory computer-readable medium of claim 14, further comprising instructions that, when executed by the one or more processors, cause the one or more processors to receive a request relating to at least one of: transmitting, or receiving of data.

17. The non-transitory computer-readable medium of claim 16, further comprising instructions that, when executed by the one or more processors, cause the one or more processors to, based on the request and the determined health status of each of the plurality of nodes, identify at least one available node from the plurality of nodes.

18. The non-transitory computer-readable medium of claim 17, further comprising instructions that, when executed by the one or more processors, cause the one or more processors to cause the identified available node to be used for completing the request.

19. The non-transitory computer-readable medium of claim 14, wherein the network architecture is displayed in a hierarchical manner.

20. The non-transitory computer-readable medium of claim 14, further comprising instructions that, when executed by the one or more processors, cause the one or more processors to update the network architecture periodically to reflect the current health status of the plurality of nodes.
